(19) United States
(12) Patent Application Publication
(10) Pub. No.: US 2005/0046883 A1
(43) Pub. Date: Mar. 3, 2005

(54) Color-space transformation-matrix calculating system and calculating method

(75) Inventor: Toru Chiba, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/923,724

(22) Filed: Aug. 24, 2004

(30) Foreign Application Priority Data
Aug. 29, 2003 (JP) P2003-307069

(51) Int. Cl. H04N 1/60

(52) U.S. Cl. 358/1.9; 358/518; 358/523; 358/504

(57) ABSTRACT

A color space transformation matrix calculating system is provided that optimizes a color space transformation matrix which transforms input colors in a first color space to corrected colors in a second color space. The system comprises, a first optimizer and a second optimizer. The first optimizer optimizes elements of the color space transformation matrix, so that the corrected colors, which are obtained by multiplying the input colors by the color space transformation matrix, coincide with goal colors, where the corrected colors and the goal colors correspond to a plurality of standard colors. The second optimizer calculates a starting point of the first optimizer by using a genetic algorithm based on the input colors and the goal colors.

### BACKGROUND OF THE INVENTION

1. Field of the Invention

The present invention relates to a color adjusting method that optimizes color signals to improve the reproduction of a color image of an object. Further, the present invention relates to a color-space transformation-matrix calculation method that optimizes matrix elements for adjusting color signals.

2. Description of the Related Art

In recent years, it has become popular to digitalize images for convenience in transmitting color information precisely between different types of media. For example, an image input device, such as a digital camera, an image scanner, and so on, transform color images of an object to signals representing the three primary colors, such as RGB signals, and then output the signals to an image output device, such as a monitor, a printer, and the like. Generally, the image output device reproduces the color image in accordance with the RGB signals, i.e. indicating an image on a screen or printing out an image on paper. The RGB signals obtained by the image input device depend on the characteristics of the optical system of the photographing lens, color filter, imaging device, and so on. Further, the images reproduced by the image output device are also different from one another in regard to how they are reproduced even when the same RGB signals are supplied. Furthermore, the characteristics of the image input device and the image output device are different, since each device has peculiar characteristics. Therefore the reproduction of a color image based on the RGB signals is disadvantageous for reproducing the original color of the object. Therefore, the RGB signal based method is poor in reproducing precise color.

Accordingly, color signals based on the sRGB standard which is a standard for the image input devices and image output devices, is generally used at present. The image input device outputs color signals after transforming the obtained RGB signals to signals based on the sRGB standard. Thereby, precise color reproduction is performed as long as the image output devices are compatible with the sRGB standard. Namely, tints quite similar to the original object can be reproduced. A variety of methods for performing color adjustment are known in the art. For example, the reproduced color is converted to the original color by adjusting the spectrum characteristics of an optical filter, provided in an imaging system, to the sRGB standard or by transforming the RGB signals electronically by a matrix transformation.

Conventionally, multiple linear regression analysis is used to improve the accuracy of color transformation methods that use a color space transformation matrix for electronic color adjustment. The multiple linear regression analysis optimizes the matrix elements by a statistical analysis which considers the relationship between the original color and the reproduced color as a cause and effect relationship. Namely, the matrix elements are obtained by optimizing these elements under the condition that the difference between the signal levels of the predicted reproduced colors, which is obtained by performing a provisional color space transformation matrix operation on the RGB signals from the imaging system, and the signal levels of the original colors, is below or equal to a permissible value. For example, a method that uses multiple linear regression analysis to provide a matrix that transforms RGB signals to XYZ signals of a different calorimetric system, is disclosed in the Japanese unexamined patent publication (KOKAI) No. 10-164381.

### SUMMARY OF THE INVENTION

Therefore, an object of the present invention is to provide a color space transformation matrix that is able to transform input colors represented in a first color space to desired colors in a second color space.

According to the present invention, a color space transformation matrix calculating system is provided that optimizes a color space transformation matrix which transforms input colors in a first color space to corrected colors in a second color space. The system comprises, a first optimizer and a second optimizer. The first optimizer optimizes elements of the color space transformation matrix, so that the corrected colors, which are obtained by multiplying the input colors by the color space transformation matrix, coincide with goal colors, where the corrected colors and the goal colors correspond to a plurality of standard colors. The second optimizer calculates a starting point of the first optimizer by using a genetic algorithm based on the input colors and the goal colors.

### BRIEF DESCRIPTION OF THE DRAWINGS

The objects and advantages of the present invention will be better understood from the following description, with reference to the accompanying drawings in which:

FIG. 1 schematically illustrates the general construction of the color space transformation matrix calculating system according to an embodiment of the present invention;

FIG. 2 illustrates the principle of how the color space transformation matrix is calculated and an input color and how a goal color in the Lab color space is depicted;

FIG. 3 is a block diagram schematically showing the processes that are carried out in the color space transformation matrix calculating process and the relationships between each of the color signals; and

FIGS. 4A-4C are flow charts of the color space transformation calculating processes.

### DESCRIPTION OF THE PREFERRED EMBODIMENTS

The present invention is described below with reference to the embodiments shown in the drawings.

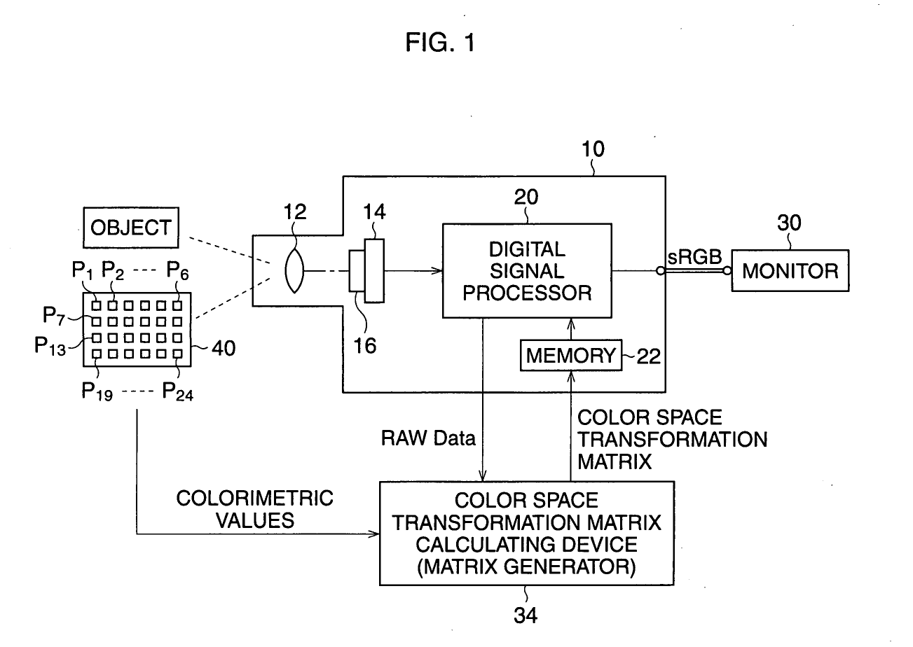

FIG. 1 schematically illustrates a system for calculating the color space transformation matrix that is used in an image signal processing device, according to an embodiment of the present invention.

The digital still camera 10 is an example of an image input device that captures a full color image of an object by using an imaging device. The digital still camera 10 includes an imaging optical system 12 and an imaging device, such as a CCD 14. The CCD 14, for example, is provided with an RGB color chip filter 16 which is mounted in front of the imaging surface of the CCD 14. An optical image produced on the imaging device, through the imaging optical system 12, is subjected to photoelectrical conversion by the CCD 14 and output therefrom as analog signals. The output analog signals are then subjected to analog signal processes and A/D conversion. Thereby the digital image signals are fed to a digital signal processor 20 as one frame of RAW data.

The digital signal processor 20, carries out a color separation process, a white balance adjusting process, a color adjusting process, and a gradation adjusting process, in this order, and generates the sRGB signals in the second color space. The color separation process generates RGB signals from the RAW data for each pixel. The white balance adjusting process optimizes each of the R, G, and B gains in accordance with the standard white signal values. The color adjusting process transforms the color gamut of the primary RGB signals in the first color space to the gamut defined by the sRGB standard in order to bring the reproduced colors close to the objective colors (ex. the original color of the object). The gradation adjusting process optimizes the gradation to counterbalance the gamma characteristics of the monitor 30. The digital signal processor 20 is able to transmit the sRGB signals to external devices, including an image output device, such as the monitor 30 (CRT or LCD) connected to a personal computer, a printer (not depicted) and so on, via an interface (not depicted).

In the digital signal processor 20, the signal processing is carried out based on the sRGB standard. However, devices having characteristics matching the sRGB standard are not always used by the imaging system (including the imaging optical system 12, CCD 14, RGB color chip filter 16, etc.). Therefore, the color information of the object obtained by this system is not precisely adjusted to the sRGB standard and the reproduced colors do not coincide with the original colors. Although various types of optical compensating techniques have been provided to compensate for the sensitivity characteristics of the imaging system, regarding the sRGB standard, they are not sufficient to achieve the complete coincidence. In fact, the attainment of complete coincidence is extremely difficult.

Therefore, the discrepancy in the characteristics of the imaging system regarding the sRGB standard may be compensated for by electronically adjusting the signal level of the RGB signals obtained by the imaging system. However, the sensitivity characteristics of the imaging system are peculiar to each digital still camera, and are different from each other. Therefore, it is impossible to logically define the relationship between the original color information of the object and the color information obtained by the digital still camera 10, since they do not have any regular relationship, so that the signal processing should include processes that are peculiar to each of the colors. When each of the R, G, and B signals is represented by 8-bit data, the number of colors will become (2⁸)³=167777216, thus it is impractical to carry out optimum color adjusting processes for all the colors.

Consequently, the color adjusting process is carried out by using a color space transformation matrix that transforms particular standard colors, selected in a predetermined color space, to colors that are aimed. For example, a color chart of which color patches (standard colors) are distributed uniformly over a uniform color space may be used. When improvement of color reproduction is required, the color space transformation matrix is obtained by using a color chart having a plurality of color samples where the saturation and hue are phased, such as the Macbeth color checker 40 (registered trademark). The Macbeth color checker 40 has 24 color patches P₁-P₂₄ as described in FIG. 1 (only part of the color patches are numbered for convenience), and eighteen color patches (P₁-P₁₈), excluding six achromatic or gray scale color patches, are used as the above standard colors. Namely, the elements of the matrix are defined so that the RGB signals of the color patches (standard colors), obtained by the digital still camera 10, coincide with the corresponding RGB signals accurately measured by a calorimeter, which will be referred to as goal colors. Further, the color chart must be imaged by the digital still camera 10 under the same illumination conditions adopted in the color determination carried out by the calorimeter. When the object is imaged, the color adjusting process performed by the digital signal processor 20 is carried out by applying the above-obtained color space transformation matrix. Thereby, high fidelity color reproduction can be achieved with respect to the values obtained by the calorimeter.

The color space transformation matrix may be obtained by an externally provided color space transformation-matrix calculating device or matrix generator 34, such as a personal computer, and may be initially stored in a memory 22 of the digital still camera 10. The digital still camera 10 transmits the RAW data, which are obtained by means of imaging the Macbeth color checker 40, from the digital signal processor 20 to the matrix generator 34. The color space transformation matrix is a 3×3 matrix that is determined at the final stage of the manufacturing processes of the digital still camera 10, in cooperation with the matrix generator 34, where the nine matrix elements of the matrix are determined depending on the spectral sensitivity characteristics of the individual imaging system mounted in each digital still camera 10.

The relationships between the input RGB signals Cᵢₙ (Rᵢₙ, Gᵢₙ, Bᵢₙ) and the output RGB signals Cₑₛ (Rₑₛ, Gₑₛ, Bₑₛ) can be described by a linear equation, such as Eq. (1), where “Cᵢₙ” denotes an input color which is given by the RAW data, “M” denotes the color space transformation matrix, and “Cₑₛ” denotes a corrected color which is obtained by using the color transformation matrix M for the input color Cᵢₙ. Further, the below Eq. (2) describes Eq. (1) by using the matrix elements, where variables m₁-m₉ are the matrix elements of the color space transformation matrix M.
Ces=M·Cin

$$( \begin{matrix}{R}_{es} \\ {G}_{es} \\ {B}_{es}\end{matrix} ) = ( \begin{matrix}{m}_{1} & {m}_{2} & {m}_{3} \\ {m}_{4} & {m}_{5} & {m}_{6} \\ {m}_{7} & {m}_{8} & {m}_{9}\end{matrix} ) ( \begin{matrix}{R}_{i n} \\ {G}_{i n} \\ {B}_{i n}\end{matrix} ) \qquad ( 2 )$$

Note that, since the purpose of the present embodiment is to achieve precise color reproduction, the objective values or goals that are set for calculating the color space transformation matrix M are preset to the calorimetric values of the color patches (standard colors) P₁-P₁₈. However, when it is desirable to reproduce particular colors, such as human skin color or a blue-sky color, as preferred colors and not the precise colors, the values which are obtained by matching the colorimetric values with reference to the particular colors, may be preset as the objective values.

Since the Macbeth color checker 40 is a ready-made item on the market, it is easy to obtain. Further, since the calorimetric values of the patches P₁-P₂₄ are already known, it can save time and expense for the colorimetric operations. Further, the color chart is not restricted to the Macbeth color checker chart described in the present embodiment, but can also be a color chart of which color patches are distributed uniformly over a uniform color space, such as the JIS standard color chart. The color space transformation matrix obtained based on the Macbeth color checker 40 can precisely reproduce the colors corresponding to each of the color patches P₁-P₁₈, however, it does not guarantee the precise reproduction of other colors. Therefore, when a peculiar color chart that includes the specific colors (human skin color, blue sky color, and verdure color), which may appear frequently in photography, is prepared and used, these specific colors can be reproduced with fidelity.

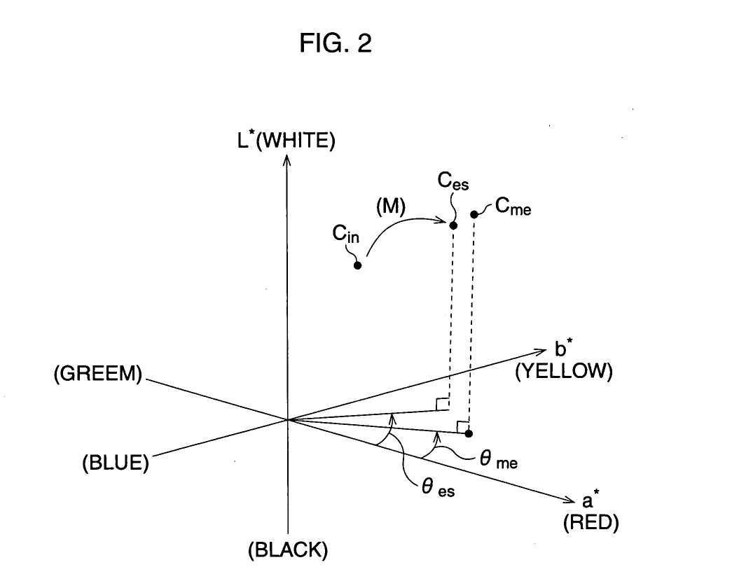

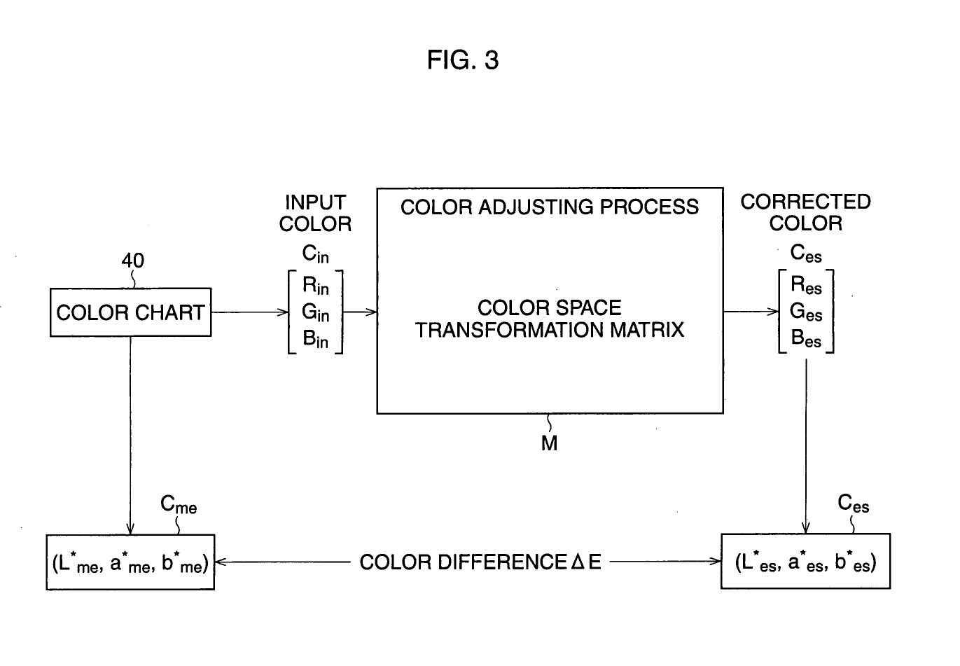

With reference to FIG. 2 and FIG. 3, the calculation of the color space transformation matrix will be explained. In FIG. 2, the CIE-L*a*b* color space (in the following, simply referred to as Lab color space) is depicted, where the light source illuminates light at a predetermined color temperature. An input color Cᵢₙ, a corrected color Cₑₛ, and an objective or goal color Cₘₑ are indicated as respective points in this Lab color space, where the input color Cᵢₙ corresponds to a color that is obtained by imaging one of the standard colors, the corrected color Cₑₛ corresponds to a color that is transformed from the input color Cᵢₙ by multiplying by the color space transformation matrix M, which has not been optimized, and the goal color Cₘₑ corresponds to a color to which the input color should be adjusted, such that the values that are obtained by the calorimeter. FIG. 3 is a block diagram schematically showing the processes being carried out in the color space transformation matrix calculating process and the relationships between each of the color signals.

In the matrix operations of the present embodiment, colors are dealt with in the same way as RGB signals. However, L*a*b* signals are used to evaluate the coincidence between the colors. This is because the Lab color space is a uniform color space of which distance is accommodated with the color difference perceived by the human eyes. Note that, the transformation from RGB signals to L*a*b* signals is performed using the following well known Eqs. (3) and (4). Eq. (3) is a formula to transform the RGB signals to the XYZ signals. Eq. (4) is a formula to transform the XYZ signals to the L*a*b* signals. When evaluating the coincidence of colors, the RGB signals are transformed to the L*a*b* signals via the XYZ signals.

$$( \begin{matrix}X \\ Y \\ Z\end{matrix} ) = ( \begin{matrix}0.4124 & 0.3576 & 0.1805 \\ 0.2126 & 0.7152 & 0.0722 \\ 0.0193 & 0.1192 & 0.9505\end{matrix} ) ( \begin{matrix}R \\ G \\ B\end{matrix} ) \qquad ( 3 )$$

where, a viewing angle of a standard observer is 2° and the standard CIE-D₆₅ illumination is used.
L*=116×f(Y)−16
a*=500×{f(X)−f(Y)}
b*=200×{f(Y)−f(Z)} (4)
where
f(X)=X^{1/3} when X/95.047≦0.008856,
f(X)=7.787X+16/116 when 0.008856<X/95.047,
f(Y)=Y^{1/3} when Y/100.000≦0.008856,
f(Y)=7.787Y+16/116 when 0.008856<Y/100.000,
f(Z)=Z^{1/3} when Z/108.883≦0.008856, and
f(Z)=7.787Z+16/116 when 0.008856<Z/108.883.

In the present embodiment, the color space transformation matrix M is optimized, so that all of the corrected colors Cₑₛ that are obtained by multiplying the color space transformation matrix M with the input colors Cᵢₙ, which relate to the eighteen colors of the color patches P₁-P₁₈, substantially coincide with those of the corresponding respective goal colors Cₘₑ. More specifically, the elements m₁-m₉ of the color space transformation matrix M are optimized by using the genetic algorithm and the damped least square method, so that the sum of the squares of the color differences ΔE between the corrected colors Cₑₛ and the goal colors Cₘₑ in the Lab space for all eighteen colors is less than or equal to a permissible error. Note that, the color difference ΔE between the corrected color Cₑₛ and the goal color Cₘₑ, in the Lab space, is defined by Eq. (5), where L*a*b* signals of the corrected color Cₑₛ are denoted by (L*ₑₛ, a*ₑₛ, b*ₑₛ) and of a goal color Cₘₑ by (L*ₘₑ, a*ₘₑ, b*ₘₑ).

$$Δ E = {\{ {( Δ {L}^{*} )}^{2} + {( Δ {a}^{*} )}^{2} + {( Δ {b}^{*} )}^{2} \}}^{\frac{1}{2}} \qquad ( 5 )$$

where, ΔL*=L*ₘₑ−L*ₑₛ Δa*=a*ₘₑ−a*ₑₛ Δb*=b*ₘₑ−b*ₑₛ.

To discriminate each of the color differences corresponding to the eighteen colors, the color differences will be indexed by the numbers of the color patches, for example ΔE₁, ΔE₂, . . . , ΔE₁₈. With respect to Eqs. (1) through (5), the color difference ΔEᵢ (i=1, 2, . . . , 18) can be considered as a function ΔEᵢ(mⱼ) which includes the matrix elements mⱼ (j=1, 2, . . . , 9) as parameters. In the damped least square method of the present embodiment, the sum square of ΔEᵢ (i=1, 2, . . . , 18) obtained for each of the eighteen colors is defined as a merit function φ of Eq. (6). The matrix elements mⱼ (j=1, 2, . . . , 9) are optimized in order to make the value of the merit function φ below or equal to a predetermined threshold value. The conditions under which the merit function φ is minimumized are given by nine equations which are represented by Eq. (7). However, since Eq. (6) is nonlinear, the matrix elements mⱼ can not be solved analytically. Therefore, the color differences ΔEᵢ are linearized about the starting point mⱼ₀. When substituting the linearized color differences ΔEᵢ, the merit function φ is expressed by a quadratic expression of mⱼ. Thus, substituting this quadratic formula into Eq. (7), a normal equation of the least square method which is expressed by the linear equation with nine unknowns is obtained. By solving this linear equation, approximate solutions for the matrix elements mⱼ (j=1, 2, . . . , 9) are obtained.

$$\begin{matrix}ϕ = {\sum }_{i = 1}^{18} {( Δ {E}_{i} )}^{2} & ( 6 ) \\ \begin{matrix}\frac{\partial ϕ}{\partial {m}_{j}} = 0 & & & ( j = 1 , 2 , … 9 )\end{matrix} & ( 7 )\end{matrix}$$

By deforming this normal equation to obtain displacement Δmⱼ, from the starting point mⱼ₀ toward the solution, it is expressed as Eq. (8). The Δm denotes a column vector, where the elements Δmⱼ (j=1, 2, . . . , 9) represent displacement from the starting point m₁₀-m₉₀ toward the solution for each mⱼ. The ΔE denotes a column vector, where the elements ΔEᵢ (i=1, 2, . . . , 18) represent the color differences, and A denotes a Jacobian matrix at the starting point mⱼ₀. Further, ( )^{t} denotes a transposed matrix and ( )⁻¹ denotes an inverse matrix.
Δm=−(A^{t}·A)⁻¹·A^{t}·ΔE (8)
where,

$$\begin{matrix}\begin{matrix}Δ m = ( \begin{matrix}Δ {m}_{1} \\ Δ {m}_{2} \\ ⋮ \\ Δ {m}_{9}\end{matrix} ) & & & Δ E = ( \begin{matrix}Δ {E}_{1} \\ Δ {E}_{2} \\ ⋮ \\ Δ {E}_{9}\end{matrix} )\end{matrix} \\ \begin{matrix}A = ( \begin{matrix}{a}_{1 \_ 1} & {a}_{1 \_ 2} & ⋯ & {a}_{1 \_ 9} \\ {a}_{2 \_ 1} & ⋯ & ⋯ & {a}_{2 \_ 9} \\ ⋮ & ⋮ & ⋮ & ⋮ \\ {a}_{18 \_ 1} & ⋯ & ⋯ & {a}_{18 \_ 9}\end{matrix} ) & & & {a}_{i \_ j}\end{matrix} = \frac{\partial Δ {E}_{i}}{\partial {m}_{j}} {\vert}_{{m}_{j} = {m}_{jo}}\end{matrix}$$

Therefore, approximate solutions for the matrix elements m₁l-m₉ are obtained by adding the displacement Δm₁, Δm₂, . . . , Δm₉ (obtained from Eq. (8) by substituting given initial values to the starting point m₁₀-m₉₀) to the starting point m₁₀-m₉₀. Further, the approximate solution obtained by the above process then becomes a new starting point mⱼ₀ and a new approximate solution for the matrix elements m₁-m₉ is again obtained. This operation is repeated until the merit function φ yields a value below or equal to the threshold value. When the value of the merit function reaches a point below or equal to the threshold value, the approximate values at that time are determined to have converged to a solution of the matrix elements m₁-m₉ and are set as the elements.

Note that, the merit function φ is not restricted to Eq. (6). For example, as shown in Eq. (9), a function wherein a term of the sum square of Δmⱼ multiplied by a damping factor D (>0), is added to the sum square of the color differences ΔEᵢ, may be adopted for the merit function φ, in order to secure the convergence of the solution, and for efficiency. As the value of the damping factor D increases, the approximation error decreases, but the speed of convergence is reduced. The method using the damping factor D is well known in the art, so it is not detailed here. In the present embodiment, the damping factor D is set to a predetermined value. However, the value of the damping factor D may be altered during the iteration process for obtaining the approximate solution. In this case, the normal equation is expressed as Eq. (10).

$$ϕ = {\sum }_{i = 1}^{18} Δ {E}_{i}^{2} + D {\sum }_{j = 1}^{9} Δ {m}_{j}^{2} \qquad ( 9 )$$

Δm=−(A^{t}·A+D·I)⁻¹·A^{t}·ΔE (10)
where, “I” in Eq. (10) denotes a unit matrix.

In the above-described optimization of the matrix, the difference between the corrected color Cₑₛ and the goal color Cₘₑ is merely evaluated by the color difference ΔE in the Lab space. However, the difference Δθ (see Eq. (11)) between the hue angles θₑₛ and θₘₑ of the above corrected and goal colors Cₑₛ and Cₘₑ may be incorporated into the evaluation in order to give priority to the hue coincidence, since human eyes are sensitive to a difference in hue rather than saturation. The hue angle (e.g. θₑₛ and θₘₑ) is a rotating angle of a point, which is obtained by projecting each point (e.g. corrected color Cₑₛ and goal color Cₘₑ) in the three-dimensional Lab color space onto the a*b*-plane, about the origin measured from the a*-axis (see FIG. 2). An equation in which the sum of the squares of the hue angle differences Δθ is added to the first term of right-hand side of Eq. (9) is expressed as Eq. (12). Note that, the hue angle differences Δθ are small compared to the color difference ΔE, so that the hue angle differences Δθ in Eq. (12) may be weighted to improve the coincidence of hue.

$$\begin{matrix}Δ θ = {θ}_{me} - {θ}_{es} = {tan}^{- 1} ( \frac{{b}_{me}^{*}}{{a}_{me}^{*}} ) - {tan}^{- 1} ( \frac{{b}_{es}^{*}}{{a}_{es}^{*}} ) & ( 11 ) \\ ϕ = {\sum }_{i = 1}^{18} \{ {( Δ {E}_{i} )}^{2} + {( Δ {θ}_{i} )}^{2} \} + D {\sum }_{j = 1}^{9} Δ {m}_{j}^{2} & ( 12 )\end{matrix}$$

Furthermore, the color differences between the corrected colors Cₑₛ and the goal colors Cₘₑ for each of the colors are distributed uniformly in the matrix optimization process using the merit function φ, which is defined by one of Eq. (6), (9), and (12). However, when it is necessary to improve the hue coincidence of particular colors, such as human skin color, the color differences ΔEᵢ may be weighted by the weights Wᵢ (i=1, 2, . . . , 18), which are given to each of the eighteen colors. The sum of the weights W₁-W₁₈ is 1. The merit function, when the weights Wᵢ are applied to the merit function φ of Eq. (9) is expressed by Eq. (13). With this weighting, the color reproduction for a particular color is improved since the weighting for the particular color is enhanced.

$$ϕ = {\sum }_{i = 1}^{18} {( {W}_{i} \cdot Δ {E}_{i} )}^{2} + D {\sum }_{j = 1}^{9} Δ {m}_{j}^{2} \qquad ( 13 )$$

When the initial values for the starting point mⱼ₀ are properly given in the calculation of the optimization, the number of iterations is reduced and thus the computing time is shortened. However, the damped least square method has disadvantage in a global optimization, since it tends to trap at a local minimum solution when the initial values are inappropriately preset. On the other hand, the genetic algorithm is known as an optimizing method that has the ability to avoid becoming trapped in the local minimum problem. However, the genetic algorithm result in the heavy calculation load and the increase of the calculation load does not contribute to the accuracy of the optimization. Further, it includes numbers of parameters to be set. Therefore, in the present embodiment, the genetic algorithm and the damped least square method are combined together to mutually compensate for their respective disadvantages, so that the reliability and the calculation speed are increased. Namely, the genetic algorithm is primarily utilized to provide the initial values for the starting point mⱼ₀ of the damped least square method. In turn, the damped least square method is carried out to optimize the matrix. Note that, the solution derived by the genetic algorithm is not necessarily required to be a local or global solution, as long as it can lead the damped least square method to the optimum solution.

In the present embodiment, the search area (e.g. from −2.048 to 2.048) for each elements mⱼ (j=1, 2, . . . , 9) of the color space transformation matrix, which are optimizing variables, is uniformly quantumized, for example, as 12-bit data, so that the encoding is carried out by combining each of the elements mⱼ, which are represented by 12-bit data, together. Namely, nine matrix elements mⱼ are encoded as genetic information of 108-bit (9×12 bit) data. As the initial set or population, one hundred individuals (i.e. matrices) are generated at random. The evaluation functions gₖ (k=1 to 100) that are used to evaluate the fitness value for each of the individuals are calculated based on ΔEᵢ (i=1 to 18), for example, α/ΔEᵢ where α is a constant. Note that, the hue angles may be incorporated into the evaluation function in a manner similar to Eq. (12) or some particular colors may be weighted in the evaluation function in a manner similar to Eq. (13).

Further, the expectation selection is adopted in the embodiment. Namely, the expectation of each of the individuals is obtained based on the sum of the evaluation functions G=Σgₖ (k=1 to 100) and the evaluation value of each of the individuals, for example, gₖ/G, so that each of the individuals is regenerated in accordance with their expectation values. The individual which has higher expectation than the other individuals is regenerated more. The individuals are rearranged in new order in accordance with their evaluation scores, and fifty individuals with higher scores are selected out. Namely, the total number of the regenerated individuals is fifty. In turn, fifty new individuals are generated at random and they are paired with the above fifty individuals which are regenerated based on the expectation selection. The pairing is carried out in accordance with the evaluation score order in each set and the crossover may be performed. Whether to perform the crossover in each of the pairs is determined at random. When it comes to performing the crossover, a pair of chromosomes (i.e. matrix elements) where the crossover is performed is determined at random. For example, the mutation rate is preset to 5%. The above-processes are repeated over generations until a predetermined terminating condition is satisfied.

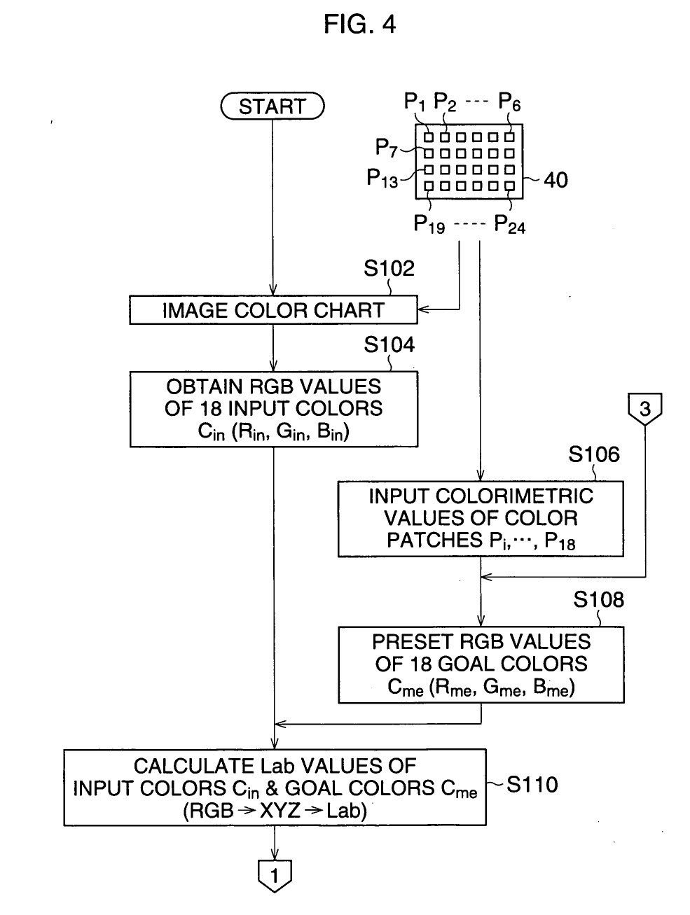

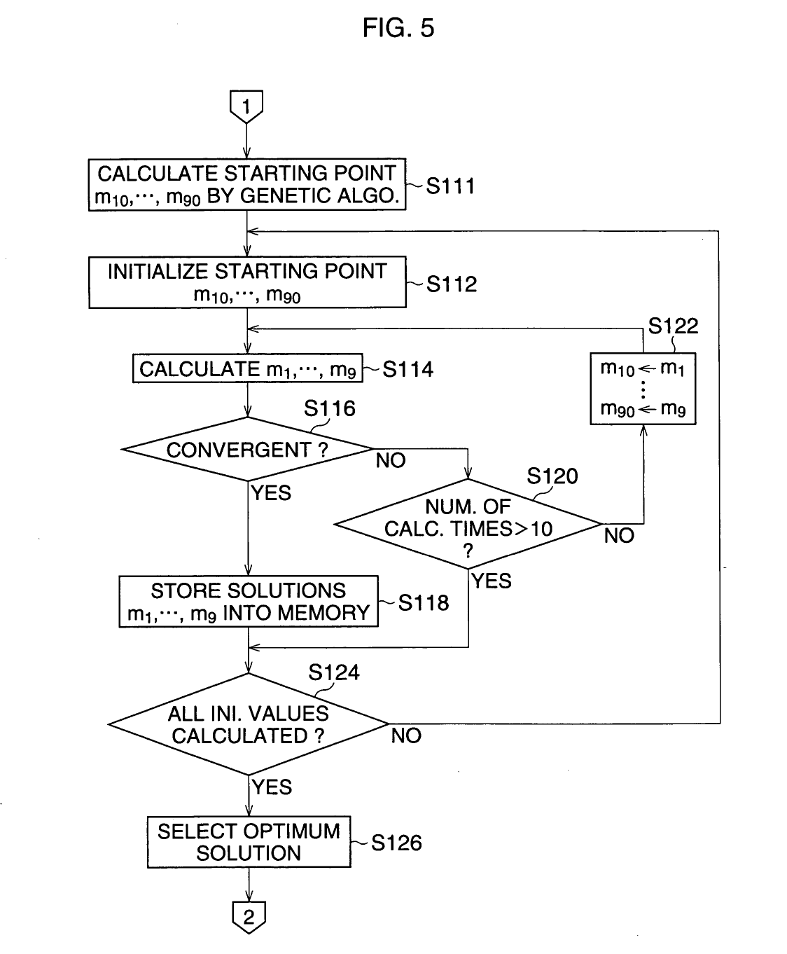

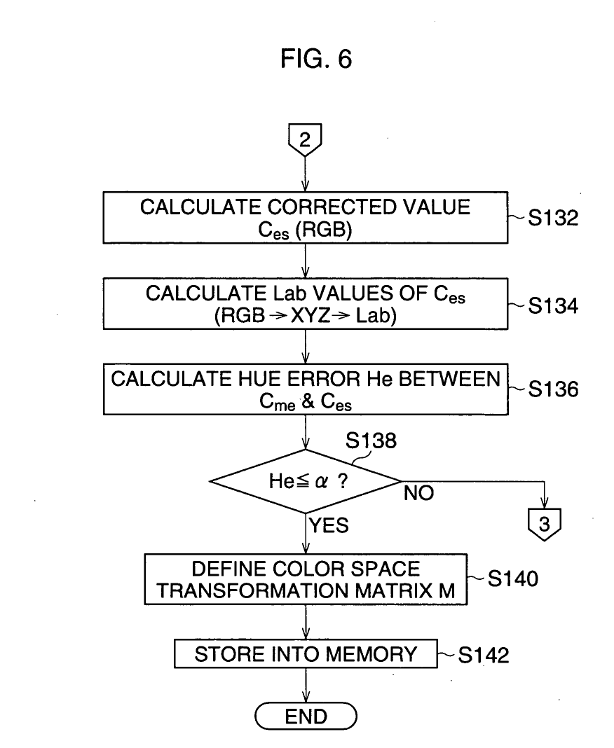

Next, with reference to the flow charts of FIGS. 4A to 4C, the color space transformation calculating process is explained in detail.

In Step S102, twenty-four color patches P₁-P₂₄ of the Macbeth color checker 40 are imaged by the digital still camera 10 under a predetermined illumination condition, and then the RAW data obtained by the preceding photographing operations are transmitted to the matrix generator 34. The matrix generator 34 obtains the RGB signals of the input colors Cᵢₙ(i) (i=1 to 18), which correspond to the eighteen chromatic color patches P₁-P₁₈, in accordance with the RAW data (Step S104). Here, the RGB signals (Rᵢₙ(i), Gᵢₙ(i), Bᵢₙ(i)) of the input color Cᵢₙ(i) are the mean values of each of the RGB signals selected from the imaging area corresponding to the color patch Pᵢ. Further, the RGB signals (Rᵢₙ(i), Gᵢₙ(i), Bᵢₙ(i)) of the input color Cᵢₙ(i) for the eighteen chromatic color patches Pᵢ (i=1, 2, . . . , 18) obtained in step S104 have already been subjected to the gray scale correction and the white balance correction, and are regularized at γ=1.0.

On the other hand, in step S106, the calorimetric signals (RGB signals) of the eighteen color patches P₁-P₁₈ are input to the matrix generator 34. In step S108, the calorimetric signals for eighteen colors, given in step S106, are preset as the RGB signals (Rₘₑ(i), Gₘₑ(i), Bₘₑ(i)) of the goal color Cₘₑ(i) for each of the color patches Pᵢ.

In step S110, the RGB signals (Rᵢₙ(i), Gᵢₙ(i), Bᵢₙ(i)) of the eighteen input colors Cᵢₙ(i) (i=1, 2, . . . , 18), obtained in step S104, are transformed to the L*a*b* signals via the XYZ signals using Eqs. (3) and (4). Similarly, the RGB signals (Rₘₑ(i), Gₘₑ(i), Bₘₑ(i)) of the eighteen goal colors Cₘₑ(i) (i=1, 2, . . . , 18), obtained in step S108 are transformed to the L*a*b* signals.

In step S111, the genetic algorithm is carried out to give appropriate values to the initial values for the starting point of the damped least square method, which is performed in steps S112-S126 to optimize the color space transformation matrix M.

In step S112, one of the solutions that is obtained by the genetic algorithm at step S111 is preset as the initial values for starting point m₁₀-m₉₀. In step S114, the displacement Δm₁, Δm₂, . . . , Δm₉ from the starting point toward the solution is obtained from the normal equation (10) of the above-mentioned damped least square method, and thereby an approximate solution for the matrix elements m₁-m₉ is derived. In step S116, whether the approximate solution is sufficiently close or substantially equal to the real solution is determined. Namely, whether the sum of squares of the color differences ΔE₁ to ΔE₁₈, in the Lab space, is within the permissible error range is determined. When it is determined that the predicted solution has converged or is close enough to the real solution, the predicted solution is provisionally stored in the memory (not shown) of the matrix generator 34 in step S118 and the process proceeds to step S124. On the other hand, when it is determined, in step S116, that the predicted solution has not converged, whether the calculation in step S114 has been iterated more than ten times is further determined in step S120. When the iteration has not reached ten times, the values of the starting point mⱼ₀ are altered by the current or provisional solutions mⱼ in step S122, and the process returns to step S114. When the iteration of the calculation in step S114 has exceeded ten times, the process proceeds to step S124 from step S120. Note that, in the present embodiment, the number of times necessary for iteration to achieve the convergence is predicted to be about four or five times, thus the limit for iterations is preset to ten times. However, the number of times for the iteration is not restricted to that of the present embodiment.

The optimum solution that is obtained by the damped least square method of steps S114 to S122 is affected by the initial values of the starting point m₁₀-m₉₀, which are designated in step S112. Therefore, in the present embodiment, a plurality of solutions derived by the genetic algorithm optimization of step S111 are, in turn, preset as the initial values of the damped least square method. The damped least square method may be carried out for all of fifty pairs of solutions that were obtained by the genetic algorithm or only for several solutions with the high fitness values. In step S124, whether the optimizing process for every set of initial values has been completed, is determined. When it is not completed, the process returns to step S112 and a set of initial values that have not been used for the calculation are preset as new initial values and the optimizing calculation is again carried out. When it is determined that the optimizing process has been carried out for all sets of initial values, the process proceeds to step S126. At this time, a plurality of solutions for the matrix elements m₁-m₉ that satisfy the condition that the sum of the squares of the color differences ΔE₁ to ΔE₁₈ for all eighteen colors is below or equal to permissible error, is stored in the memory.

In step S126, the optimum solution is selected from the plurality of solutions for the matrix elements m₁-m₉. Namely, a solution that gives the minimum sum of the squares of the hue angle differences Δθ₁, Δθ₂, . . . , Δθ₁₈ between the corrected colors Cₑₛ(1)-Cₑₛ(18) and the goal colors Cₑₛ(1)-Cₘₑ(18), is selected, so that the corrected colors Cₑₛ(1)-Cₑₛ(18) are obtained by using the color space transformation matrix in which a solution of the matrix elements is preset. Therefore, the matrix elements m₁-m₉, obtained in step S126, give the sum of the squares of the color differences ΔE₁ to ΔE₁₈, for each of the eighteen colors of the Macbeth color checker 40, which is below or equal to the permissible error, and minimize the sum square of the hue angle differences Δθ₁ to Δθ₁₈.

Note that, the conditions for selecting the optimum solution are not restricted to the present embodiment, and can be altered based upon particular requirements. For example, when it is necessary to give priority to a selected color, such as human skin color, a severe condition for the color difference between the corrected color Cₑₛ and the goal color Cₘₑ for the selected color (i.e. human skin color), may be added.

In steps S132-S142, the validity of the obtained color space transformation matrix M is evaluated. In step S132, the obtained solution is preset for the color space transformation matrix M, and then the RGB signals (Rₑₛ(1), Gₑₛ(1), Bₑₛ(1))-(Rₑₛ(18), Gₑₛ(18), Bₑₛ(18)) of the corrected colors Cₑₛ(1)-Cₑₛ(18) are obtained by using the color space transformation matrix M for the input colors Cᵢₙ(1)-Cᵢₙ(18), see Eqs. (1) and (2). Further, in step S134, the L*a*b* signals (L*ₑₛ(1) a*ₑₛ(1), b*ₑₛ(1))-(L*ₑₛ(18), a*ₑₛ(18), b*ₑₛ(18)) of the corrected colors Cₑₛ(1)-Cₑₛ(18) are obtained by using Eqs. (3) and (4) via the XYZ signals.

Further, in step S136, the hue angle differences Δθ₁ to Δθ₁₈ are calculated by Eq. (11), based on the L*a*b* signals (L*ₑₛ(1), a*ₑₛ(1), b*ₑₛ(1))-(L*ₑₛ(18), a*ₑₛ(18), b*ₑₛ(18)) of the corrected colors Cₑₛ(1)-Cₑₛ(18) that have been calculated in step S134 and the L*a*b* signals (L*ₘₑ(1), a*ₘₑ(1), b*ₘₑ(1))-(L*ₘₑ(18), a*ₘₑ(18), b*ₘₑ(18)) of the goal colors Cₘₑ(1)-Cₘₑ(18) that have been calculated in step S110. In turn, the hue error “Hₑ”, which is the sum of the squares of the hue angle differences Δθ₁ to Δθ₁₈, is obtained by Eq. (14).

$${H}_{e} = {\sum }_{i = 1}^{18} {( Δ {θ}_{i} )}^{2} \qquad ( 14 )$$

In step S138, whether the hue error Hₑ is below or equal to a permissible value a is determined. When the hue error Hₑ is above the permissible value α, the process returns to step S108 and at least one of the goal colors Cₘₑ(1)-Cₘₑ(18) is replaced, and further a new color space transformation matrix M is calculated. Note that, when returning to step S108 and when the RGB signals of the goal colors Cₘₑ(1)-Cₘₑ(18) are altered, each of the values should be determined under the condition of making only a small change in hue, so as not to change the tint of a reproduced color on the monitor 30 from the original color of the object.

When it is determined, in step S138, that the hue error He is below or equal to the permissible value α, the color space transformation matrix M is determined as a matrix that transforms the input colors Cᵢₙ to values which precisely approximate the goal colors Cₘₑ with respect to hue. Accordingly, in step S140, the current matrix elements of the color space transformation matrix M are determined as the solution, and then, in step S142, the matrix elements of the color space transformation matrix M are transmitted from the matrix generator 34 to the digital still camera 10 and are stored in the memory 22.

Accordingly, when using the above-obtained color space transformation matrix M for a color adjusting process of the digital still camera 10, sRGB signals based on the calorimetric signals are obtained with fidelity. Therefore, an image having colors quite close to the original object colors can be displayed on the monitor 30.

As described above, in the present embodiment, the color space transformation matrix, which is used to correct color, is obtained by means of the genetic algorithm and the damped least square method. Namely, the initial values for the starting point of the damped least square method are made appropriate by using the genetic algorithm, so as to prevent the calculation of the damped least square method from being trapped in a local optimum solution and also reduce the computing time.

Note that, the image input device is not restricted to the digital still camera 10 of the present embodiments, but it can also be any type of device, such as digital video camera, scanner, electronic endoscope, and the like. Further, in the present embodiments, the matrix generator 34 is configured as a device external to the digital still camera 10, however the matrix generating function may be incorporated into the digital still camera 10. Furthermore, it may be configured as an image processing software application that is able to calculate the color space transformation matrix and is able to correct colors, so that the software may be installed in a personal computer system and the RAW data from the digital still camera 10 are subjected to the color correction processes in the personal computer system.

In the present embodiments, the color space transformation matrix that adjusts colors of RGB signals obtained by the imaging system is based on the sRGB standard. However, the matrix calculating methods in the present embodiments are not restricted to the calculation of a matrix that is specific to this type of color correction. For example, a color space transformation matrix that interactively transforms color signals between different color spaces, such as a transformation of RGB signals to XYZ signals or to CMYK signals for printing, and a transformation of CMY signals for complementary colors to RGB signals, may be calculated by the above-discussed method.

Although, in the present embodiment, the coincidence between the colors is evaluated in the Lab space, the evaluation can be carried out in the other color spaces.

In the present embodiment, the damped least square method is mentioned as an example of optimizing method that tends to be trapped in a local optimum solution. However, the genetic algorithm can also be combined with the other optimizing methods that tend to be trapped in the local optimum solution, such as the gradient method.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Applications No. 2003-307069 (filed on Aug. 29, 2003), which is expressly incorporated herein, by reference, in its entirety.

1. A color space transformation matrix calculating system that optimizes a color space transformation matrix which transforms input colors in a first color space to corrected colors in a second color space, the system comprising:
a first optimizer that optimizes elements of said color space transformation matrix, so that said corrected colors, which are obtained by multiplying said input colors that correspond to a plurality of standard colors by said color space transformation matrix, coincide with goal colors that correspond to said plurality of standard colors; and
a second optimizer that calculates a starting point of said first optimizer by using a genetic algorithm based on said input colors and said goal colors.

2. A system according to claim 1, wherein said first optimizer comprises a damped least square method.

3. A system according to claim 1, wherein said first color space comprises RGB signals obtained by an imaging system and said second color space comprises sRGB signals.

4. A system according to claim 1, wherein the coincidence between said corrected colors and said goal colors is evaluated in a third color space.

5. A system according to claim 4, wherein said third color space comprises uniform color space.

6. A system according to claim 1, wherein said plurality of standard colors is given as a plurality of color patches and said input colors are obtained by imaging said plurality of color patches under a predetermined illumination condition.

7. A system according to claim 1, wherein said plurality of standard colors is given as a plurality of color patches and said goal colors are obtained by measuring said plurality of color patches with a colorimeter under a predetermined illumination condition.

8. A method for optimizes a color space transformation matrix which transforms input colors in a first color space to corrected colors in a second color space, said method comprising:
optimizing elements of said color space transformation matrix, so that said corrected colors, which are obtained by multiplying said input colors that correspond to a plurality of standard colors by said color space transformation matrix, coincide with goal colors that correspond to said plurality of standard colors; and
calculating a starting point of said first optimizer by using a genetic algorithm based on said input colors and said goal colors.

9. A computer program product for calculating a color space transformation matrix which transforms input colors in a first color space to corrected colors in a second color space, said computer program comprising:
optimizing elements of said color space transformation matrix, so that said corrected colors, which are obtained by multiplying said input colors that correspond to a plurality of standard colors by said color space transformation matrix, coincide with goal colors that correspond to said plurality of standard colors; and
calculating a starting point of said first optimizer by using a genetic algorithm based on said input colors and said goal colors.
